(19) United States
(12) Patent Application Publication
(10) Pub. No.: US 2011/0235898 A1
(43) Pub. Date: Sep. 29, 2011

(54) MATCHING PROCESS IN THREE-DIMENSIONAL REGISTRATION AND COMPUTER-READABLE STORAGE MEDIUM STORING A PROGRAM THEREOF

(75) Inventors: Masaharu Watanabe, Osaka (JP); Fumiaki Tomita, Osaka (JP)

(73) Assignee: NATIONAL INSTITUTE OF ADVANCED INDUSTRIAL SCIENCE AND TECHNOLOGY, Tokyo (JP)

(21) Appl. No.: 13/053,819

(22) Filed: Mar. 22, 2011

(30) Foreign Application Priority Data
Mar. 24, 2010 (JP) 2010-067445

(51) Int. Cl. G06K 9/32

(52) U.S. Cl. 382/154

(57) ABSTRACT

The matching process includes: finding first and second three-dimensional reconstruction point sets that contain three-dimensional position coordinates of segments, and first and second feature set that contain three-dimensional information regarding vertices of the segments, from image data of an object (S2 to S4); and matching the first feature set with the second feature set, thereby determining a corresponding point of the first and second three-dimensional reconstruction point sets (S5 to S10), wherein Step S5 carries out initial matching with respect to the segments; Step S6 selects a feature point from the first feature set; Step S7 specifies an adjustment region containing the selected feature point; Step S8 carries out fine adjustment of matching with respect to the segments within the adjustment region; and Steps S6 to S8 are performed at each increase of the adjustment region and at each selection of the feature point.

### TECHNICAL FIELD

The present invention relates to a matching process in three-dimensional registration for integrating a group of multiple partial three-dimensional data items into a single three-dimensional data item, or required for model-based object recognition techniques etc.; and a computer-readable storage medium storing a program of the method.

### BACKGROUND ART

Three-dimensional registration (aligning) refers to a technique of integrating a group of multiple partial three-dimensional data items obtained by stereo image-processing, laser range finder, or the like into a single data form. Three-dimensional registration is used in a wide range of fields, such as surveying, ruin investigation, modeling, industrial component inspection etc. During the registration, the relative positions of the items in the data group are informed by external information (e.g., camera calibration before the measurement) other than the measurement data.

During the registration process, errors in the information of relative positions become problematic; however, it is known that registration can be accurately performed without precise relative positions by performing fine adjustment using the ICP (Iterative Closest Point) algorithm. This allows three-dimensional registration to be used for a wide range of purposes. For example, the following Non-patent Literatures 1 and 2 disclose a method of obtaining three-dimensional data of an object from two images captured at different viewpoints.

### CITATION LIST

### Non-Patent Literature

[Non-patent Literature 1] Fumiaki Tomita, Hironobu Takahashi, “Matching Boundary-Representations of Stereo Images”, THE TRANSACTIONS OF THE INSTITUTE OF ELECTRONICS AND COMMUNICATION ENGINEERS OF JAPAN, D, vol. J71-D, No. 6, pp. 1074-1082, June 1988

### [Non-Patent Literature 2]

Yasushi Sumi, Fumiaki Tomita, “Three-Dimensional Object Recognition Using Stereo Vision”, THE TRANSACTIONS OF THE INSTITUTE OF ELECTRONICS, INFORMATION AND COMMUNICATION ENGINEERS, D-II, vol. J80-D-II, No. 5, pp. 1105-1112, May 1997

### SUMMARY OF INVENTION

### Technical Problem

However, since the ICP algorithm performs error correction using only information of other data groups in the vicinity of the reference data, it may not be as reliable as expected if the preliminary information of relative positions is inaccurate. For example, when the ICP algorithm is performed to measure an object in which at least one side is much shorter than the other sides, as in the rectangular solid shown in FIG. 9, using inaccurate initial information, the initial information may contain an error such that the straight line of the measurement data item 1 comes close to a incorrect straight line of the measurement data item 2, as shown in FIG. 9. If the fine adjustment using the ICP algorithm is performed with such an error, it may fail to converge toward the correct answer due to the adjacent incorrect matching data (the area shown as the gray ellipse in FIG. 9).

Although this error occurs between the data groups, the same problem occurs in the model-based object recognition technique, which is a technique for matching three-dimensional measurement information with a previously created three-dimensional geometric model, thereby measuring the location and pose of a real object expressed by the model; this technique is regarded as three-dimensional registration in a broad sense.

Further, if preliminary information regarding relative positions of the data items constituting a group cannot be obtained, initial matching is performed using features such as vertices so as to reduce the calculation time; it is not realistic, in terms of time and costs, to perform the registration by verifying every single combination of all information of the data groups. However, in this case, the matching result may contain an error from the true value due to the noise contained in the data feature point. For example, when vertices are used as a feature, the locations and poses of the two straight lines obviously contain measurement noises that affect the matching results. This may result in data such as the initial matching result shown in FIG. 9. Therefore, at the stage of fine adjustment using all of the data by the ICP algorithm or the like, the process may not converge toward the correct answer for the reason stated above.

An object of the present invention is to provide a matching method capable of accurate three-dimensional registration even without precise initial registration information; and a computer-readable storage medium storing the program.

### Solution to Problem

An object of the present invention is attained by the following means.

A first matching process in three-dimensional registration according to the present invention comprises the steps of:

(1) finding a first three-dimensional reconstruction point set and a first feature set from two image data items obtained by capturing images of an object at two different viewpoints;

(2) finding a second three-dimensional reconstruction point set and a second feature set from two image data items obtained by capturing images of the object at two different viewpoints which differ from the viewpoints in Step (1);

3) matching the first feature set with the second feature set, thereby determining, among the second three-dimensional reconstruction point set, points that corresponds to a point in the first three-dimensional reconstruction point set,

wherein:

the first and second three-dimensional reconstruction point sets respectively contain three-dimensional position coordinates of segments obtained by dividing a boundary of the object in the corresponding two image data items;

the first and second feature sets respectively contain three-dimensional information regarding vertices of the segments;

Step (3) comprises the steps of

(4) carrying out initial matching with respect to the segments of the first and second three-dimensional reconstruction point set;

(5) selecting a feature point from the first feature set;

(6) specifying a region containing the feature point as an adjustment region; and

(7) carrying out fine adjustment of matching with respect to the segments of the first and second three-dimensional reconstruction point sets within the adjustment region;

Step (7) is performed at each increase of the adjustment region; and

Steps (6) and (7) are performed at each selection of the feature point.

A second matching process according to the present invention is arranged such that, based on the first invention,

the segments are approximated by straight lines, arcs, or a combination of straight lines and arcs;

the three-dimensional information regarding the vertices comprises three-dimensional position coordinates and two types of three-dimensional tangent vectors of the vertices;

the matching in Step (3) is a process for finding a transformation matrix for three-dimensional coordinate transformation, thereby matching a part of the first feature set with a part of the second feature set; and

the process of determining, among the second three-dimensional reconstruction point set, a point that corresponds to a point in the first three-dimensional reconstruction point set in Step (3) is a process for evaluating a concordance of a result of the three-dimensional coordinate transformation of the point of the first three-dimensional reconstruction point set using the transformation matrix with the point of the second three-dimensional reconstruction point set.

A third matching process in three-dimensional registration according to the present invention comprises the steps of:

(1) finding a three-dimensional reconstruction point set and a feature set from two image data items obtained by capturing images of an object at two different viewpoints;

(2) finding a model data set and a model feature set of the object;

3) matching the feature set with the model feature set, thereby determining, among the three-dimensional reconstruction point set, points that corresponds to a point in the model data set,

wherein:

the three-dimensional reconstruction point set contains three-dimensional position coordinates of segments obtained by dividing a boundary of the object in the two image data items;

the feature set contains three-dimensional information regarding vertices of the segments;

Step (3) comprises the steps of

(4) carrying out initial matching of the segments of the three-dimensional reconstruction point set with the model feature set;

(5) selecting a feature point from the model feature set;

(6) specifying a region containing the feature point as an adjustment region; and

(7) carrying out fine adjustment of matching with respect to the segments contained in the three-dimensional reconstruction point set and the model feature set within the adjustment region;

Step (7) is performed at each increase of the adjustment region; and

Steps (6) and (7) are performed at each selection of the feature point.

A fourth matching process according to the present invention is arranged such that, based on the third invention,

the segments are approximated by straight lines, arcs, or a combination of straight lines and arcs;

the three-dimensional information regarding the vertices comprises three-dimensional position coordinates and two types of three-dimensional tangent vectors of the vertices;

the matching in Step (3) is a process for finding a transformation matrix for three-dimensional coordinate transformation, thereby matching a part of the model feature set with a part of the feature set; and

the process of determining, among the three-dimensional reconstruction point set, points that corresponds to a point in the model data set in Step (3) is a process for evaluating a concordance of a result of the three-dimensional coordinate transformation of the point of the model data set using the transformation matrix with the point of the three-dimensional reconstruction point set.

A first computer-readable storage medium according to the present invention stores a program for causing a computer to execute the functions of:

(1) finding a first three-dimensional reconstruction point set and a first feature set from two image data items obtained by capturing images of an object at two different viewpoints;

(2) finding a second three-dimensional reconstruction point set and a second feature set from two image data items obtained by capturing images of the object at two different viewpoints which differ from the viewpoints in Step (1);

3) matching the first feature set with the second feature set, thereby determining, among the second three-dimensional reconstruction point set, points that corresponds to a point in the first three-dimensional reconstruction point set,

wherein:

the first and second three-dimensional reconstruction point sets respectively contain three-dimensional position coordinates of segments obtained by dividing a boundary of the object in the corresponding two image data items;

the first and second feature sets respectively contain three-dimensional information regarding vertices of the segments;

Step (3) comprises the steps of

(4) carrying out initial matching with respect to the segments of the first and second three-dimensional reconstruction point set;

(5) selecting a feature point from the first feature set;

(6) specifying a region containing the feature point as an adjustment region; and

(7) carrying out fine adjustment of matching with respect to the segments of the first and second three-dimensional reconstruction point sets within the adjustment region;

the program causes the computer to execute Step (7) at each increase of the adjustment region; and

the program causes the computer to execute Steps (6) and (7) at each selection of the feature point.

A second computer-readable storage medium according to the present invention is arranged such that, based on the first computer-readable storage medium,

the segments are approximated by straight lines, arcs, or a combination of straight lines and arcs;

the three-dimensional information regarding the vertices comprises three-dimensional position coordinates and two types of three-dimensional tangent vectors of the vertices;

the matching in Step (3) is a process for finding a transformation matrix for three-dimensional coordinate transformation, thereby matching a part of the first feature set with a part of the second feature set; and

the process of determining, among the second three-dimensional reconstruction point set, a point that corresponds to a point in the first three-dimensional reconstruction point set in Step (3) is a process for evaluating a concordance of a result of the three-dimensional coordinate transformation of the point of the first three-dimensional reconstruction point set using the transformation matrix with the point of the second three-dimensional reconstruction point set.

A third computer-readable storage medium according to the present invention stores a program for causing a computer to execute the functions of:

(1) finding a three-dimensional reconstruction point set and a feature set from two image data items obtained by capturing images of an object at two different viewpoints;

(2) finding a model data set and a model feature set of the object;

3) matching the feature set with the model feature set, thereby determining, among the three-dimensional reconstruction point set, points that corresponds to a point in the model data set,

wherein:

the three-dimensional reconstruction point set contains three-dimensional position coordinates of segments obtained by dividing a boundary of the object in the corresponding two image data items;

the feature set contains three-dimensional information regarding vertices of the segments;

Step (3) comprises the steps of

(4) carrying out initial matching of the segments of the three-dimensional reconstruction point set with the model feature set;

(5) selecting a feature point from the model feature set;

(6) specifying a region containing the feature point as an adjustment region; and

(7) carrying out fine adjustment of matching with respect to the segments contained in the three-dimensional reconstruction point set and the model feature set within the adjustment region;

the program causes the computer to execute Step (7) at each increase of the adjustment region; and

the program causes the computer to execute Steps (6) and (7) at each selection of the feature point.

A fourth computer-readable storage medium according to the present invention is arranged such that, based on the third computer-readable storage medium,

the segments are approximated by straight lines, arcs, or a combination of straight lines and arcs;

the three-dimensional information regarding the vertices comprises three-dimensional position coordinates and two types of three-dimensional tangent vectors of the vertices;

the matching in Step (3) is a process for finding a transformation matrix for three-dimensional coordinate transformation, thereby matching a part of the model feature set with a part of the feature set; and

the process of determining, among the three-dimensional reconstruction point set, points that corresponds to a point in the model data set in Step (3) is a process for evaluating a concordance of a result of the three-dimensional coordinate transformation of the point of the model data set using the transformation matrix with the point of the three-dimensional reconstruction point set.

### Advantageous Effects of Invention

According to the present invention, the fine adjustment after the initial matching is performed by matching the images with a gradual increase of the target area (propagation matching). In this manner, the present invention makes it possible to perform three-dimensional registration with high accuracy without falling into a local minimum etc. in the process of integrating a group of multiple partial three-dimensional data items into a single three-dimensional data item, or in the model-based object recognition techniques.

### BRIEF DESCRIPTION OF DRAWINGS

FIG. 1 A block diagram showing a schematic structure of a device for carrying out the present invention.

FIG. 2 A flow chart showing a matching method according to an embodiment of the present invention.

FIG. 3 A drawing showing an increase of an adjustment region.

FIG. 4 A trihedral view showing a matching object in an Example.

FIGS. 5a-5b Photos of matching objects.

FIGS. 6a-6b Drawings showing the registration results of an adjustment when using only a segment pair as a feature point.

FIGS. 7a-7b Drawings showing the registration results according to a conventional method.

FIGS. 8a-8b Drawings showing the registration results according to the present invention.

FIG. 9 A perspective view showing false matching.

### DESCRIPTION OF EMBODIMENTS

An embodiment of the present invention is described below in reference to the attached drawings.

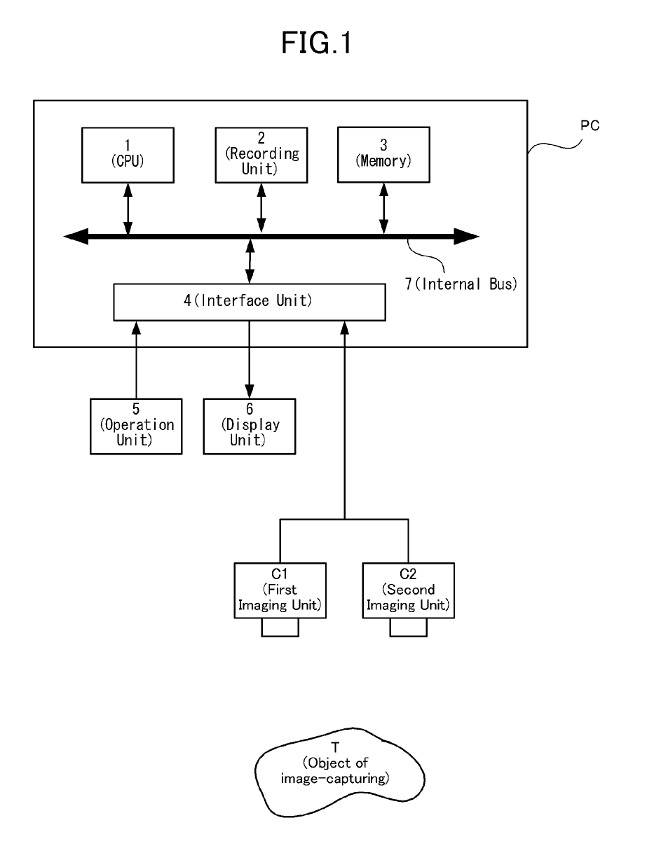

FIG. 1 is a block diagram showing a schematic structure of a device for carrying out the present invention. The present device is composed of a computer PC, and imaging units C1 and C2. The computer PC comprises an arithmetic processing unit (hereinafter referred to as a CPU) 1, a recording unit 2 for recording data, a storage unit (hereinafter referred to as a memory) 3, an interface unit 4, an operation unit 5, a display unit 6, and an internal bus 7 for exchanging data (including control information) between units.

The CPU 1 reads out a predetermined program from the recording unit 2, and develops the data in the memory 3 to execute predetermined data processing using a predetermined work area in the memory 3. The CPU 1 records, as required, results of ongoing processing and the final results of completed processing in the recording unit 2. The CPU 1 accepts instructions and data input from the operation unit 5 via the interface unit 4, and executes the required task. Further, as required, the CPU 1 displays predetermined information in the display unit 6 via the interface unit 4. For example, the CPU 1 displays a graphical user interface image showing acceptance of input via the operation unit 5 in the display unit 6. The CPU 1 acquires information regarding conditions of the user's operation of the operation unit 5, and executes the required task. For example, the CPU 1 records the input data in the recording unit 2, and executes the required task. Computer keyboards, mice, etc. may be used as the operation unit 5. CRT displays, liquid crystal displays, etc. may be used as the display unit 6.

The first and second imaging units C1 and C2 are disposed in predetermined positions at a predetermined interval. The first and second imaging units C1 and C2 capture images of a target object T, and send resulting image data to the computer PC. The computer PC records the image data sent from the imaging units via the interface unit 4 in a manner to distinguish the two data items from each other; for example, by giving them different file names according to the imaging unit. When the output signals from the first and second imaging units C1 and C2 are analog signals, the computer PC comprises an AD (analogue-digital) conversion unit (not shown) to sample the input analog signals supplied at predetermined time intervals into digital data. When the output signals from the first and second imaging units C1 and C2 are digital data, the AD conversion unit is not necessary. The first and second imaging units C1 and C2 are at least capable of capturing still pictures, optionally capable of capturing moving pictures. Examples of the first and second imaging units include digital cameras, and digital or analog video cameras.

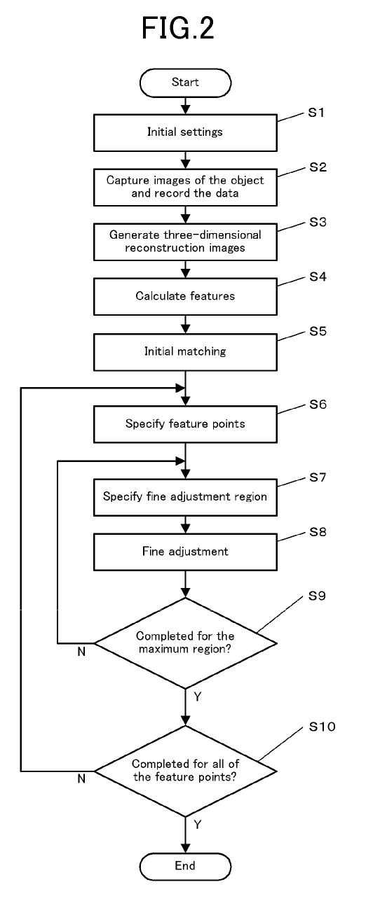

An embodiment of the present invention is described below in reference to the flow chart of FIG. 2. For ease of understanding, the following embodiment carries out the registration of two three-dimensional reconstruction images. The two kinds of three-dimensional reconstruction images both contain a region Tc of a target object T; more specifically, one of the three-dimensional reconstruction images is composed of a region Ta and the region Tc of the target object T, and the other three-dimensional reconstruction image is composed of a region Tb and the region Tc of the target object T. Therefore, the two three-dimensional reconstruction images are integrated based on the common region Tc. It is also possible to perform the registration using three or more three-dimensional reconstruction images in the same way.

In the following description, all operations are carried out by a CPU 1; more specifically, the CPU 1 causes the respective units to execute the operations, unless otherwise specified. The internal and external parameters of the first and second imaging units C1 and C2 are found beforehand by a calibration test, and stored in the recording unit 2.

In Step S1, the initial settings are made. The initial settings are required to enable the processes in Step S2 and later steps. In the initial settings, for example, the control protocol and data transmission path for the first and second imaging units C1 and C2 are established to enable control of the first and second imaging units C1 and C2.

In Step S2, images of the target object T are captured by the first and second imaging units C1 and C2 at two different locations. The captured images are sent to the computer PC and recorded in the recording unit 2 with predetermined file names. In this manner, two pairs of two-dimensional image data, each of the pairs containing two images captured at two different locations, are stored in the recording unit 2. In this embodiment, each item of two-dimensional image data is expressed as Mij, where i denotes the location of image-capturing, and j denotes either the first and second imaging units C1 and C2.

In Step S3, the two pairs of dimensional image data captured and stored in the recording unit 2 in Step S2 are read out to generate two three-dimensional reconstruction images. More specifically, the two images M11 and M12 (hereinafter referred to as a pair of images) are read out to generate a three-dimensional reconstruction image, and the other two images M21 and M22 are also read out to generate another three-dimensional reconstruction image. Here, each three-dimensional reconstruction image is constructed by stereo correspondence; however, the correspondence is not found by points (pixels), but by more comprehensive units—“segments”. This can reduce the search space to a considerable degree, compared with the point-based image reconstruction. For the detailed processing method, the conventional method disclosed in the above Non-patent Literature 1 can be referenced. The following explains only the operation related directly to the present invention.

The reconstruction is performed by carrying out a series of three-dimensional reconstruction processes by sequentially subjecting each image of the pair of images to (a) edge detection, (b) segment generation, and (c) three-dimensional reconstruction by evaluation of segment connectivity and correspondence between the images. Hereinafter, a set of three-dimensional reconstruction points regarding the pair of images obtained in Step S3 is represented by Fi. As mentioned above, i denotes the location of image-capturing; in other words, i discriminates the pair.

### (a) Edge Detection

Any known image-processing method can be used for edge detection of each image. For example, the strength and direction of the edge of each point of the image are found by a primary differential operator; and a closed edge (also referred to as a boundary) surrounding a region is obtained by non-maximum suppression, thresholding, and edge extension.

### (b) Segment Generation

Segments are generated using the two edge images obtained above. A “segment” is obtained by dividing an edge into a plurality of line (straight line) components. At first, the boundary is tentatively divided with a predetermined condition, and the segments are approximated by straight lines according to the method of least squares. Here, if there are any segments having a significant error, the segment is divided at a point most distant from the straight line connecting the two ends of the segment (a point having the largest perpendicular line with respect to the straight line in the segment). This process is repeated to determine the points to divide the boundary (divisional point), thereby generating segments for each of the two images, and further generating straight lines for approximating the segments.

The processing result is recorded in the recording unit 2 as a boundary representation (structural data). More specifically, each image is represented by a set of multiple regions. Each region R is represented by a list of an external boundary B of the region and a boundary H with respect to the inner hole of the region. The boundaries B and H are represented by a list of segments S. Each region is defined by values representing a circumscribed rectangle that surrounds the region, and a luminance. Each segment is oriented so that the region containing the segment is seen on the right side. Each segment is defined by values representing coordinates of the start point and the end point, and an equation of the straight line that approximates the segment. Such data construction is performed for the two images. The following correspondence process is performed on the data structure thus constructed.

### (c) Three-Dimensional Reconstruction

Next, corresponding segments are found from the two images. Although the segments represent images of the same object, it is not easy to determine correspondences of the segments because of the variable lighting conditions, occlusion, noise, etc. Therefore, first, correspondences are roughly found on a region basis. As a condition to determine a correspondence of a pair of the regions, it is necessary to satisfy that the difference between the luminances of the regions is equal to or less than a certain value (for example, a level 25 for 256-scale luminance), and that the regions contain points satisfying the epipolar condition. However, since this is not a sufficient condition, multiple corresponding regions may be found for a single region. More specifically, this process finds all potential pairs having the corresponding boundaries, so as to reduce the search space for finding correspondences on a segment basis. This is a kind of coarse-to-fine analysis.

Among the segments roughly assumed to compose the same boundary, potential corresponding segment pairs are found and summarized in a list. Here, as a condition to determine a correspondence of a pair of the segments, it is necessary to satisfy that the segments have corresponding portions satisfying the epipolar condition, that upward or downward orientations of the segments (each segment is oriented so that the region containing it is seen on the right side) are matched, and that the difference of angles of the orientations falls within a certain value (e.g., 45°).

Thereafter, for each of the potential segment pairs, the degree of similarity, which is represented by values C and D, is found. “C”, as a positive factor, denotes a length of the shorter segment among the corresponding two segments. “D”, as a negative factor, denotes a difference in parallax from the start point to the end point between the corresponding segments. The potential segment pairs found at this stage contain multiple correspondences in which a single segment corresponds to multiple segments on the same y axis (vertical direction). As explained below, false correspondences are eliminated according to a similarity degree and a connecting condition of the segments.

Next, for each of the two images, a list of connected segments is created. To satisfy the condition to determine the connection of two segments, it is necessary for the difference between the luminances of the regions containing the segments to be equal to or less than a certain value (for example, a level 25); and for the distance between the end point of one segment to the start point of the other segment to be less than a certain value (for example, 3 pixels). Basically, if one of the segments of a pair is a continuous segment, the other segment must be a continuous segment. Accordingly, using the connection list and correspondence list, a path showing a string of the corresponding continuous segments connected to and from the segment is found, in the following manner.
When the terminal points of the two corresponding paths are completely matched, and if there are any potential corresponding segment pairs among the segments continuous from those end points, add them to the path.
When one of the terminal points corresponds to the middle point of the other, and if there are any potential segments assumed to correspond to the segment continuous from a single segment, add them to the path.

Further, it may even be possible to determine the connection for the pairs not in direct connection. For example, when a single segment corresponds to two segments, a line component having the largest distance between the both ends of the two segments is temporarily used as a substitute for the two segments. Still further, in some cases, the two continuous segments connected via a point A correspond to two discontinuous segments. In this case, the two discontinuous segments are extended. Then, if the distance between the two points intersecting with the horizontal line that crosses the point A is small, the extended two-line components (one of the ends is the intersecting point) are temporarily determined as two corresponding segments. However, to avoid generating an unnecessarily large amount of temporarily assumed segments, the similarity degree of the temporarily assumed segments and true segments must satisfy C>|D|. In this manner, the operation is repeated until segments to be added to the path are no longer found. By performing the above operation, new temporarily assumed segments are added.

Next, assuming that the paths are projected backwards on a three-dimensional space, the segments composing the same plane are grouped. This serves not only as the plane restraint condition for finding correct segment pairs, but also as a procedure to obtain an output of the boundary on a three-dimensional plane. To confirm that the segments compose the same plane, the following plane restraint theorem is referenced.

Plane restraint theorem: For the standard camera model, with respect to an arbitrary shape on a plane, a projection image on one camera and a projection image on another camera are affine-transformable.

The theorem denotes that a set of segments that exist on the same plane is affine-transformable between stereo images even for segments on an image obtained by perspective projection, thereby enabling validation of flatness of segments on an image without directly projecting segments backwards. The grouping of the segments using the plane restraint theorem is performed as follows.

First, an arbitrary pair of two corresponding continuing segments is selected from the paths of corresponding pairs, so as to form a minimum pair group.

Then, a segment continuous to each segment of the two images is found. Assuming that all terminal points of the three segments thus found exist on the same plane, an affine transformation matrix between two pairs of continuing segments (each pair has three segments) is found according to a method of least squares. To confirm that the three segments exist on a plane, it is verified that the point obtained by affine transformation of either the right or left terminal point is identical with the other terminal point. In the present specification, concordance of two points indicates a state in which the distance between the two points is equal to or less than a predetermined value. Therefore, if the distance is equal to or less than a predetermined value (e.g., 3 pixels), it is determined that the three segments exist on the same plane.

When the above method found that the three segments exist on the same plane, a segment continuous to each of the right and left segments is found again. In this manner, an affine transformation matrix is found for the four corresponding segments, and validation is performed to determine whether the corresponding terminal points satisfy the obtained transformation matrix. Further, if the plane restraint condition is satisfied, the validation is repeated by sequentially validating continuous segments.

As a result of the above process, pairs of segment groups that constitute the plane are found. However, in some cases, multiple pair groups may be obtained with respect to a single segment pair (multiple continuing segments that constitute the plane). Therefore, the degree of shape similarity is calculated for each pair group so that each segment pair is allotted a single pair group with the maximum similarity degree. The similarity degree G of a pair group is a total of the similarity degrees C. and D of the segments contained in the pair group. In the addition, the minus factor D is given a minus sign, i.e., −D is added. Multiple correspondences indicate that there are one or more false-matching pairs. In a false-matching pair, the segment pair has a small correspondence (C is small), a large difference in parallax (|D| is large), and a small number of continuous segments. Hence, the value of similarity degree G of the pair group containing the pair becomes small. Therefore, the pair group having the maximum similarity degree G is sequentially selected, and other corresponding pair groups are eliminated. In this manner, it is possible to specify the corresponding segment pairs among two images.

With the above process, the coordinates of the segments on a three-dimensional space can be found from the differences in parallax of the corresponding segment pairs among two images. Since the differences in parallax can be calculated using functions of segments, the obtained results are based on sub-pixels. Further, the differences in parallax on the segments do not fluctuate. For example, assuming that the equations of the two corresponding segments j among two images are x=fⱼ(y) and x=gⱼ(y), the difference in parallax d between the two segments can be found by d=fⱼ(y)−gⱼ(y). In practice, the three-dimensional segments are expressed by an equation of a straight line.

Using the information and difference in parallax d of the obtained corresponding segments, and taking the positions of two cameras (imaging units) into account, a three-dimensional reconstruction point set Fi is found. A detailed explanation of the calculation method for finding three-dimensional coordinates using the two corresponding points on two images and their difference in parallax is omitted here because there are some known methods adoptable both in the case of disposing optical axes of two cameras in parallel, and in the case of disposing them via an angle of convergence.

The result obtained above is recorded in the recording unit 2 in the form of a predetermined data structure. The data structure is composed of a set of groups G* expressing three-dimensional planes. Each group G* contains information of a list of three-dimensional segments S* constituting the boundary. Each group G* has a normal direction of the plane, and each segment has three-dimensional coordinates of the start and end points, and an equation of a straight line.

In Step S4, calculation of feature of the pair image data is performed. Here, a set of “vertices”, which is a feature required for the registration of three-dimensional reconstruction images (also required for model matching), is found. A “vertex” refers to an intersection of so-called virtual straight lines, which are composed of two vectors defined by straight lines allotted to spatially adjacent three-dimensional segments. More specifically, with respect to the three-dimensional reconstruction point set Fi, the intersection of two adjacent tangent lines is found using tangent lines at terminal points of the straight lines allotted to two adjacent segments (in this example using straight lines to approximate the segments, it refers to the straight lines). The obtained intersections are defined as vertices. A set of the vertices is expressed as Vi. Further, an angle between the tangent vectors (hereinafter referred to as a narrow angle) is found.

More specifically, the feature refers to a three-dimensional position coordinate of the vertex, a narrow angle at the vertex, and two normal vector components. To find the features, the method disclosed in Non-patent Literature 2 shown above may be used.

In Step S5, initial matching of two three-dimensional reconstruction image data items is performed. More specifically, with respect to the vertex sets Vi (i=1, 2) obtained above, 4×4 (4 columns and 4 rows) coordinate transformation matrices Tj are found for all combinations (denoted by candidate number j) of vertices having similar narrow angle values, to create a solution candidate group Ca (Ca=ΣCj).

For the detailed method, the method disclosed in the above Non-patent Literature 2 can be referenced. The following explains only the operation related directly to the present invention. The transformation from a three-dimensional coordinate vector a=[x y z]t to a three-dimensional coordinate vector a′=[x′ y′ z′]t (t denotes transposition) is expressed as x′=Rx+t using a 3×3 three-dimensional coordinate rotation matrix R and a 3×1 parallel translation vector t. Therefore, the relative location/pose relationship of the two three-dimensional reconstruction images of a target object T, obtained by capturing images of the target object T at different positions, may be defined as a 4×4 coordinate transformation matrix T for moving a three-dimensional structure in one of the three-dimensional reconstruction image data items so as to match it with a corresponding three-dimensional structure of the other three-dimensional reconstruction image data item.

$$T = [ \begin{matrix} & R & & t \\ 0 & 0 & 0 & 1\end{matrix} ]$$

As described above, the initial matching is a process for comparing two vertex sets V1 and V2, thereby finding a transformation matrix T. However, since it is not possible to obtain information regarding correct correspondences of the vertices beforehand, all likely combinations are assumed to be candidates. The vertex VM among the vertex set V2 is attempted to move to match the vertex VD. According to the relationship between the three-dimensional position coordinates of the vertex VM and VD, the parallel translation vector t of the matrix T is determined. A rotation matrix R is determined according to the directions of two three-dimensional vectors constituting the vertex. If the pair has a large difference in angle θ formed of two vectors constituting the vertex, the correspondence is likely false; therefore, the pair is excluded from the candidates. More specifically, with respect to VM(i) (i=1, . . . , m) and VD(j)(j=1, . . . , n), the matrix Tᵢⱼ (0) (0 in the parentheses denotes the condition before the later-described fine adjustment) corresponding to the coordinate transformation matrix Tj is found among correspondence candidates, i.e., all combinations A(i,j) satisfying |θM(i)−θD(j)|<θth. Here, m and n respectively denote the numbers of vertices existing in the two-vertices sets V1 and V2. The threshold θth may be empirically determined, for example.

Next, Steps S6 to S10 are repeatedly performed for fine adjustment.

In Step S6, a feature point is specified for one of the three-dimensional reconstruction image data items. In this embodiment, one of the vertices in the vertex set V1 is specified.

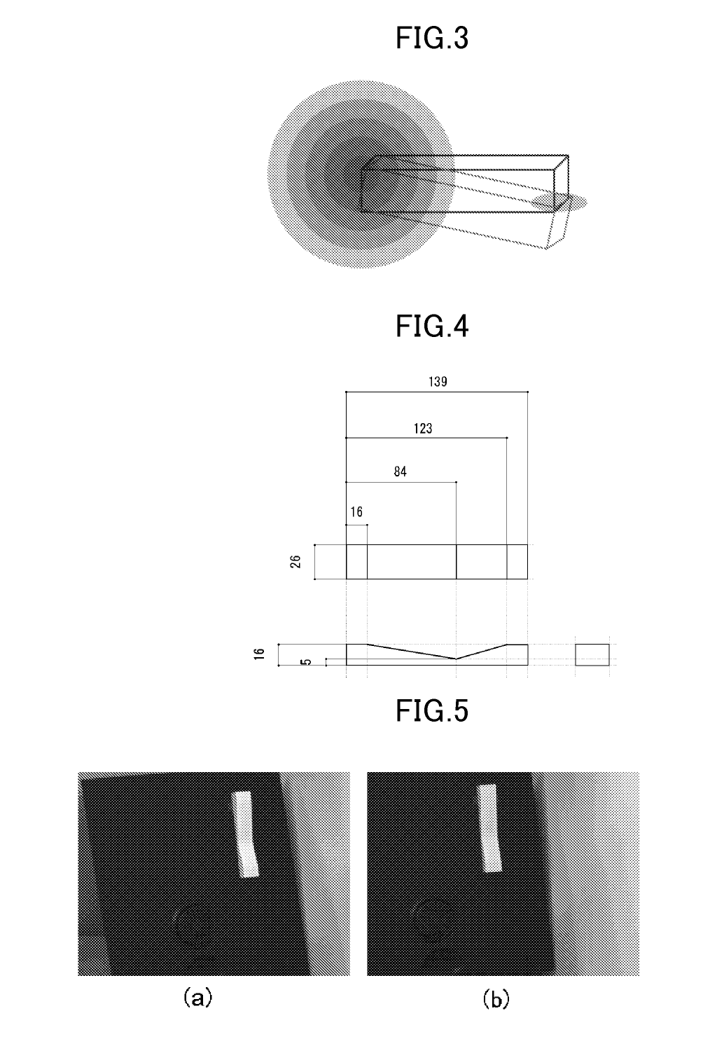

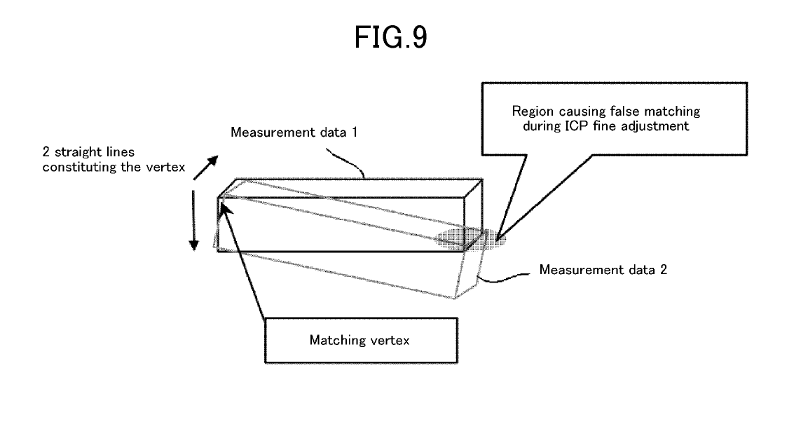

In Step S7, a region for fine adjustment is determined. For example, a radius r0 is determined, and a circular region having the radius r0 with its center residing in the feature point (vertex) specified in Step S6 is determined as a fine adjustment region. For example, in FIG. 3, among multiple circles having different luminances, a region (circular region) defined by the smallest circle is determined as a fine adjustment region. The rectangular solids shown in FIG. 3 schematically show a common region Tc of the target object T contained in the two three-dimensional reconstruction images (separate regions Ta and Tb are not shown). As with FIG. 9, FIG. 3 shows a false initial matching.

Step S8 performs fine adjustment with respect to the point in the fine adjustment region determined in Step S7. The fine adjustment is a process for finding correspondence between the points of two three-dimensional reconstruction point sets F1 and F2, thereby simultaneously determining the adequacy of A(i, j) and reducing errors contained in matrix Tij(0).

The process performs a sequence that repeats a transfer using the coordinate transformation matrix Tij(0) found by the initial matching with respect to the vertex sets V1 and V2; a search of, for example, an image data point (a point in the three-dimensional reconstruction point set F2) corresponding to the vertex of vertex set V1; and an update of coordinate transformation matrix by way of least squares. The details are according to known methods (for example, see the section of “3.2 fine adjustment” in the above Non-patent Literature 2).

Specifically, the following Sub-steps 1 to 7 are performed.

Sub-step 1: As a searching space for corresponding points, an image on which a data point sequence of two dimensional coordinates is plotted is prepared.

Sub-step 2: P(k) is moved to P′(k) by Tᵢⱼ(0). The three-dimensional coordinate P(k) of P(k) and its unit vector N (k) in the normal direction are moved respectively to:

P′(k)=Rᵢⱼ(0)P(k)+tᵢⱼ(0)

N′(k)=Rᵢⱼ(0)N(k)

Here, P(k) and N(k) are 3×1 vectors.

Sub-step 3: Among P′(k), those satisfying cos⁻¹(S′^{t}(k)·N′^{t}(k)/|S′(k)|)>π/2 is determined as P(n)(n=1, . . . , p′; p′≦p). Here, assuming that S′(k) refers to an observation directional vector corresponding to P′(k), and C is a 3×1 vector that denotes an observation location of the stereo camera system, the following condition is satisfied.

S′(k)=P′(k)+tᵢⱼ(0)−C

More specifically, P(n) denotes a vertex(vertices) observable in one of the three-dimensional reconstruction images after the vertex of the other three-dimensional reconstruction image data is moved by Tᵢⱼ(0).

Sub-step 4: The three-dimensional coordinate P(n) of P(n) in the image coordinate [colₙ, rowₙ] is projected to search for data points corresponding to the observable vertices among the data points in the other three-dimensional reconstruction image.

By a trace on the image in the normal direction of P(n) and in the vertical direction, a data point D(l)(l=1, . . . , q) within a certain distance is determined as a corresponding point of P(n). Here, q denotes the number of data points.

Sub-step 5: with respect to β (n, l), which is a combination of P(n) and D(l), an optimal transformation matrix T′ᵢⱼ is found to move P(n) to be matched with the three-dimensional coordinate D(l) of D(l) by way of least squares with the following condition for its minimum.

J=Σ_{β}|R′ᵢⱼP(n)+tᵢⱼ′−D(l)|2

Σ_{β} denotes a sum regarding β(n, l).

Sub-step 6: Sub-steps 2 to 5 are repeated on condition that T(u)=T′T(u−1) until the mean square error in the corresponding point search in Sub-step 4, more specifically, the result of the following formula, falls below the threshold.

ε2=Σ_{β} {(coln−coll)2+(corn−rowl)2}/r

Here, r denotes a total number of β (n,l), more specifically, the number of corresponding points found by the corresponding point search. r is equal to or less than p (r≦p).

If the ratio r/p, i.e., a ratio of the number of corresponding points to the number of observable vertices is small; or if the calculations did not converge to ε2 even after a certain number of processes, the correspondence candidate A(i, j) is discarded as a false candidate.

Sub-step 7: the above sequence is repeated for all items of the correspondence candidate A(i,j) so as to find Tᵢⱼ(u) having the largest r and the smallest result for the formula:

ε2=Σβ|(Rᵢⱼ(u)P(n)+tᵢⱼ(u)−D(l)|2/r.

Since the initial matching uses a local geometric feature, the corresponding point search may not have sufficiently effective recognition accuracy, except for reconstruction points in the vicinity of the vertices used for calculation of Tᵢⱼ(0). Therefore, the fine adjustment process is preferably performed in the following two stages.
Initial fine adjustment: correspondence errors are roughly adjusted using only reconstruction points on the segments constituting the vertices used for initial matching.
Main fine adjustment: the accuracy is increased by using all reconstruction points.

Step S9 carries out a judgment as to whether the fine adjustment is completed for the maximum fine adjustment region. If it is not completed, the sequence goes back to Step S7 to perform another fine adjustment in a wider range. For example, the radius r0 is increased by a predetermined value Δr (r0+Δr). For example, in FIG. 3, as shown in the multiple circles with different luminances, the fine adjustment region is a (circular) region that extends with a gradual increase of a circle, starting from the central smallest circle. In this manner, Steps S7 to S9 are repeated until the fine adjustment is completed for the predetermined maximum fine adjustment region.

When the fine adjustment is completed for the maximum fine adjustment region, a judgment is carried out in Step S10 as to whether the fine adjustment is completed for all feature points in the vertex set V1. If it is not completed, the sequence goes back to Step S6 to specify feature points other than those already specified. In this manner, Steps S6 to S10 are repeated until the fine adjustment is completed for all feature points.

As described, the above method enables accurate final integration of two items of three-dimensional reconstruction image data in the fine adjustment by ICP without referring to incorrect correspondences, even in the condition where conventional location and pose measurement had poor accuracy.

The above embodiment is not to limit the present invention. More specifically, the present invention is not limited to the disclosures of the embodiment above, but may be altered in many ways.

For example, in the above embodiment, the fine adjustment is performed with respect to a specific feature point while increasing the fine adjustment region, and then performing the same process again with respect to other feature points; however, it is also possible to perform it with respect to all feature points in a fine adjustment region of predetermined size, and then performing the same process again with an increase of fine adjustment region.

Further, in the above embodiment, the fine adjustment region was determined by increasing the radius having a feature point in its center by a predetermined value; however, the present invention is not limited to this. Insofar as the fine adjustment region is gradually increased, it is possible to specify, as the fine adjustment region, a three-dimensional figure having an arbitrary shape containing the feature point. Still further, the fine adjustment region may be arbitrarily increased, for example, by a similar figure or by a different figure, at a constant proportion or a variable proportion. All of the information for specifying the fine adjustment region at each stage may be stored beforehand in the recording unit. For example, a parameter to increase the region may be stored as a string of numerical values.

Further, the above embodiment describes registration during the integration of measured three-dimensional reconstruction image data items; however, the present invention is also applicable to a model-based object recognition technique; more specifically, a technique of matching the three-dimensional measurement information with a previously created three-dimensional geometric model, thereby measuring the location and pose of a real object expressed by the model. In this case, since the geometric structure of the model is known before the matching, the region-increasing parameter may be stored as a numerical value string for each vertex. This method is also applicable to integration of two-dimensional images, and four-dimensional images involving the time axis. The dimensionality of the fine adjustment region may be appropriately determined according to the dimensionality of the data to be processed.

Further, in the above embodiment, the segments are approximated by straight lines; however, the segments may be approximated by straight lines or arcs. In this case, the arcs (for example, the radius of the arc, the directional vector or the normal vector from the center of the arc to the two terminal points, etc.) as well as the vertices can be used as features. Further, the segments may be approximated by a combination of straight lines and arcs (including a combination of multiple arcs). In this case, only the arcs in the two terminal points of the segment may be used as a feature of the segment, in addition to the vertices.

When the segments are approximated by arcs (including the case where the segments are approximated by a combination of straight lines and arcs), the calculation of the vertices in Step S4 is performed using the tangent lines at the ends of the arcs. The tangent lines of the arcs can be found by a directional vector from the center of the arc toward the two terminal points. Further, in Step S5, in addition to the process regarding the vertices, a process for finding correspondence candidates for the combination of arcs of a model and obtained image data are also performed. A parallel translation vector t can be determined by three-dimensional coordinates of the two terminal points of the arc, and a rotation matrix R can be determined by a directional vector and a normal vector from the center of the arc toward the two terminal points. It is preferable to exclude a combination of arcs having a great difference in their radii from the candidates. The total of the correspondence candidates obtained by using the vertices and the arcs, i.e., A(i,j) and Tᵢⱼ(0), is regarded as the final result of initial matching.

Further, the above embodiment is carried out by a software program using a computer; however, the present invention is not limited to this. For example, a single hardware device or multiple hardware devices (for example, dedicated semiconductor chip (ASIC) and its peripheral circuit) may be used to execute a part or the entirety of the functions divided into multiple functions. For example, when multiple hardware devices are used, the devices may comprise a three-dimensional reconstruction calculation unit for obtaining pair image data as the three-dimensional reconstruction images by way of stereo correspondence and for finding features required for matching; and a matching adjustment unit for matching corresponding points according to similarity of features of the two items of three-dimensional reconstruction image data.

### EXAMPLES

An Example of the present invention is described below to further clarify the effectiveness of the present invention.

Images of a specific object are captured using two cameras. The obtained image data and model data are matched according to the sequence shown in the flow chart of FIG. 2. In this example, the matching was performed by using one of the two items of three-dimensional reconstruction image data; however, this is the same process as that using two items of three-dimensional reconstruction image data.

As shown in the trihedral view of FIG. 4, a rectangular solid having a constriction in the vicinity of the body center was used as the object (the real object and the model).

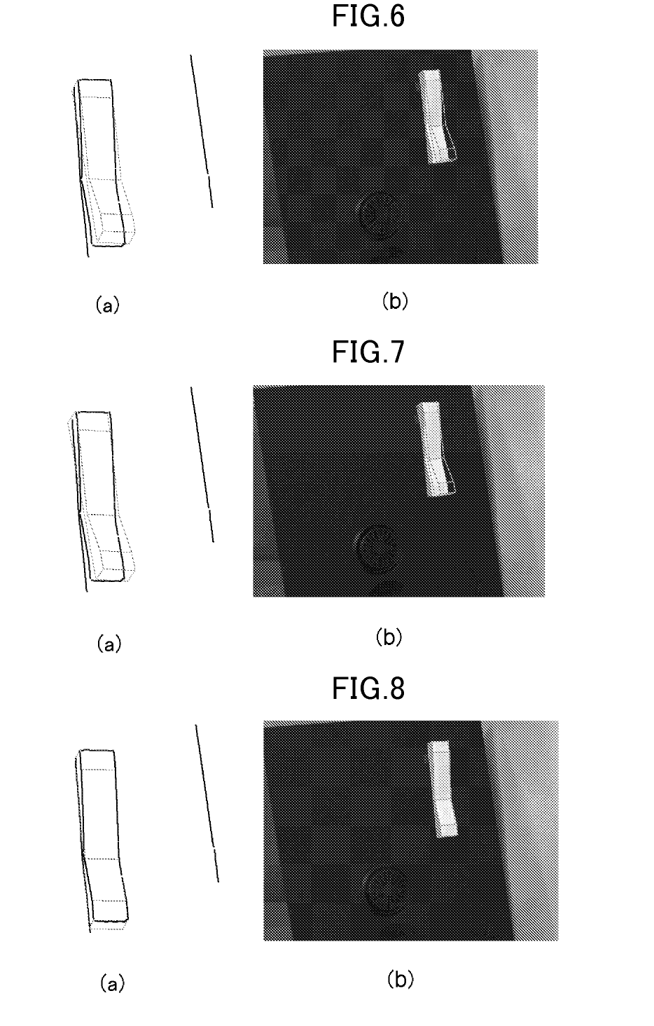

Images of the object shown in FIG. 4 were captured by two cameras, thereby obtaining two data items of the right and left images shown in FIG. 5. Using the image data items in FIG. 5, Steps S3 to S5 shown in the flow chart of FIG. 2 were performed. FIG. 6 shows a result of registration after the initial adjustment that performs matching only with respect to segments (upper part of the image) constituting the vertices; that is, a registration process at a stage before starting the matching process (propagation matching) of the present invention. The broken line denotes the data of the object, and a solid line denotes an edge obtained from the image.

Regardless of whether the propagation matching is performed, the process always has this stage. However, as shown in FIG. 6, because of inaccurate measurement data (presumably caused by inappropriate exposure time/focus, inadequate camera calibration, image noise contained in the captured image element etc.), the registration is inaccurate.

FIG. 7 shows a final result of a registration process according to a conventional method. The figure shows that the matching proceeded with respect to the bottom of the model and the upper aspect of the data in the lower region of the image; thereby, the registration was inaccurate.

FIG. 8 shows a final result of a registration process according to the present invention using propagation matching. The figure shows that the registration was accurately completed by the method of the present invention.

As described above, in the conventional method, if the result of initial matching is incorrect, the subsequent fine adjustment according to the ICP algorithm or the like using all of the data will not converge toward the correct answer. In contrast, in the present invention, the fine adjustment will converge toward the correct answer even if the result of initial matching is incorrect. The above defect of the conventional method that results in false convergence more easily occurs when the segments are small, regardless of the size and shape of the object. Therefore, the present invention is particularly effective when the segments are small, regardless of the size and shape of the object.

### REFERENCE NUMERALS

1 Arithmetic processing unit (CPU)
2 Recording unit
3 Storage unit (memory)
4 Interface unit
5 Operation unit
6 Display unit
7 Internal bus
PC Computer
C1 First imaging unit
C2 Second imaging unit
T Object of image-capturing

1. A matching process in three-dimensional registration, comprising the steps of:
(1) finding a first three-dimensional reconstruction point set and a first feature set from two image data items obtained by capturing images of an object at two different viewpoints;
(2) finding a second three-dimensional reconstruction point set and a second feature set from two image data items obtained by capturing images of the object at two different viewpoints which differ from the viewpoints in Step (1);
3) matching the first feature set with the second feature set, thereby determining, among the second three-dimensional reconstruction point set, points that corresponds to a point in the first three-dimensional reconstruction point set,
wherein:
the first and second three-dimensional reconstruction point sets respectively contain three-dimensional position coordinates of segments obtained by dividing a boundary of the object in the corresponding two image data items;
the first and second feature sets respectively contain three-dimensional information regarding vertices of the segments;
Step (3) comprises the steps of
(4) carrying out initial matching with respect to the segments of the first and second three-dimensional reconstruction point set;
(5) selecting a feature point from the first feature set;
(6) specifying a region containing the feature point as an adjustment region; and
(7) carrying out fine adjustment of matching with respect to the segments of the first and second three-dimensional reconstruction point sets within the adjustment region;
Step (7) is performed at each increase of the adjustment region; and
Steps (6) and (7) are performed at each selection of the feature point.

2. The matching process according to claim 1,
wherein:
the segments are approximated by straight lines, arcs, or a combination of straight lines and arcs;
the three-dimensional information regarding the vertices comprises three-dimensional position coordinates and two types of three-dimensional tangent vectors of the vertices;
the matching in Step (3) is a process for finding a transformation matrix for three-dimensional coordinate transformation, thereby matching a part of the first feature set with a part of the second feature set; and
the process of determining, among the second three-dimensional reconstruction point set, a point that corresponds to a point in the first three-dimensional reconstruction point set in Step (3) is a process for evaluating a concordance of a result of the three-dimensional coordinate transformation of the point of the first three-dimensional reconstruction point set using the transformation matrix with the point of the second three-dimensional reconstruction point set.

3. A matching process in three-dimensional registration, comprising the steps of:
(1) finding a three-dimensional reconstruction point set and a feature set from two image data items obtained by capturing images of an object at two different viewpoints;
(2) finding a model data set and a model feature set of the object;
3) matching the feature set with the model feature set, thereby determining, among the three-dimensional reconstruction point set, points that corresponds to a point in the model data set,
wherein:
the three-dimensional reconstruction point set contains three-dimensional position coordinates of segments obtained by dividing a boundary of the object in the two image data items;
the feature set contains three-dimensional information regarding vertices of the segments;
Step (3) comprises the steps of
(4) carrying out initial matching of the segments of the three-dimensional reconstruction point set with the model feature set;
(5) selecting a feature point from the model feature set;
(6) specifying a region containing the feature point as an adjustment region; and
(7) carrying out fine adjustment of matching with respect to the segments contained in the three-dimensional reconstruction point set and the model feature set within the adjustment region;
Step (7) is performed at each increase of the adjustment region; and
Steps (6) and (7) are performed at each selection of the feature point.

4. The matching process according to claim 3,
wherein:
the segments are approximated by straight lines, arcs, or a combination of straight lines and arcs;
the three-dimensional information regarding the vertices comprises three-dimensional position coordinates and two types of three-dimensional tangent vectors of the vertices;
the matching in Step (3) is a process for finding a transformation matrix for three-dimensional coordinate transformation, thereby matching a part of the model feature set with a part of the feature set; and
the process of determining, among the three-dimensional reconstruction point set, points that corresponds to a point in the model data set in Step (3) is a process for evaluating a concordance of a result of the three-dimensional coordinate transformation of the point of the model data set using the transformation matrix with the point of the three-dimensional reconstruction point set.

5. A computer-readable storage medium storing a program for causing a computer to execute the functions of:
(1) finding a first three-dimensional reconstruction point set and a first feature set from two image data items obtained by capturing images of an object at two different viewpoints;
(2) finding a second three-dimensional reconstruction point set and a second feature set from two image data items obtained by capturing images of the object at two different viewpoints which differ from the viewpoints in Step (1);
3) matching the first feature set with the second feature set, thereby determining, among the second three-dimensional reconstruction point set, points that corresponds to a point in the first three-dimensional reconstruction point set,
wherein:
the first and second three-dimensional reconstruction point sets respectively contain three-dimensional position coordinates of segments obtained by dividing a boundary of the object in the corresponding two image data items;
the first and second feature sets respectively contain three-dimensional information regarding vertices of the segments;
Step (3) comprises the steps of
(4) carrying out initial matching with respect to the segments of the first and second three-dimensional reconstruction point set;
(5) selecting a feature point from the first feature set;
(6) specifying a region containing the feature point as an adjustment region; and
(7) carrying out fine adjustment of matching with respect to the segments of the first and second three-dimensional reconstruction point sets within the adjustment region;
the program causes the computer to execute Step (7) at each increase of the adjustment region; and
the program causes the computer to execute Steps (6) and (7) at each selection of the feature point.

6. The computer-readable storage medium according to claim 5,
wherein:
the segments are approximated by straight lines, arcs, or a combination of straight lines and arcs;
the three-dimensional information regarding the vertices comprises three-dimensional position coordinates and two types of three-dimensional tangent vectors of the vertices;
the matching in Step (3) is a process for finding a transformation matrix for three-dimensional coordinate transformation, thereby matching a part of the first feature set with a part of the second feature set; and
the process of determining, among the second three-dimensional reconstruction point set, a point that corresponds to a point in the first three-dimensional reconstruction point set in Step (3) is a process for evaluating a concordance of a result of the three-dimensional coordinate transformation of the point of the first three-dimensional reconstruction point set using the transformation matrix with the point of the second three-dimensional reconstruction point set.

7. A computer-readable storage medium storing a program for causing a computer to execute the functions of:
(1) finding a three-dimensional reconstruction point set and a feature set from two image data items obtained by capturing images of an object at two different viewpoints;
(2) finding a model data set and a model feature set of the object;
3) matching the feature set with the model feature set, thereby determining, among the three-dimensional reconstruction point set, points that corresponds to a point in the model data set,
wherein:
the three-dimensional reconstruction point set contains three-dimensional position coordinates of segments obtained by dividing a boundary of the object in the corresponding two image data items;
the feature set contains three-dimensional information regarding vertices of the segments;
Step (3) comprises the steps of
(4) carrying out initial matching of the segments of the three-dimensional reconstruction point set with the model feature set;
(5) selecting a feature point from the model feature set;
(6) specifying a region containing the feature point as an adjustment region; and
(7) carrying out fine adjustment of matching with respect to the segments contained in the three-dimensional reconstruction point set and the model feature set within the adjustment region;
the program causes the computer to execute Step (7) at each increase of the adjustment region; and
the program causes the computer to execute Steps (6) and (7) at each selection of the feature point.

8. The computer-readable storage medium according to claim 7,
wherein:
the segments are approximated by straight lines, arcs, or a combination of straight lines and arcs;
the three-dimensional information regarding the vertices comprises three-dimensional position coordinates and two types of three-dimensional tangent vectors of the vertices;
the matching in Step (3) is a process for finding a transformation matrix for three-dimensional coordinate transformation, thereby matching a part of the model feature set with a part of the feature set; and
the process of determining, among the three-dimensional reconstruction point set, points that corresponds to a point in the model data set in Step (3) is a process for evaluating a concordance of a result of the three-dimensional coordinate transformation of the point of the model data set using the transformation matrix with the point of the three-dimensional reconstruction point set.
